(19) United States
(12) Patent Application Publication
(10) Pub. No.: US 2013/0084551 A1
(43) Pub. Date: Apr. 4, 2013

(54) Child Learning And Safety Device And Method Of Use

(71) Applicant: Leonard HOUSTON, Glendale, AZ (US)

(72) Inventor: Leonard HOUSTON, Glendale, AZ (US)

(21) Appl. No.: 13/249,866

(22) Filed: Sep. 30, 2011

(51) Int. Cl. G09B 5/04

(52) U.S. Cl. 434/319

(57) ABSTRACT

A child learning and safety device comprising: a housing, where the housing contains a plurality of internal components; an attachment means attached to the housing, wherein the attachment means enables the housing to wrap around a body part of a child user; an audio device as one of the internal components, where the audio device plays audio files; a location processor as one of the internal components, where the location processor monitors a location of the child user; one or more location sensors attached to a fixture within a building, where the location sensor activate an alarm within the location processor when the location processor comes within a predetermined distance of the location sensor; and a set of speakers positioned on the housing, where the set of speakers play the audio files and where the set of speaker sound the alarm when the location processor is activated.

### BACKGROUND OF THE INVENTION

1. Field of the Invention

The present invention relates to a device that attaches to a body part of a child, where the device plays audio files. Additionally, if the child leaves a predetermined area, an alarm sounds within the device to alert an adult as to the location of the child.

2. Description of Related Art

Parents and guardians spend countless hours monitoring and entertaining their children. Usually, if the parent is not entertaining their child, they are monitoring their whereabouts to ensure that they are safe. The safety and wellbeing of the child is always a primary focus of the parent. Every year thousands of children are abducted and taken from the families who love them. Even some of the most diligent parents have found themselves and their children victims of child abductions.

To address the problem, several devices have been developed to track and monitor the location of a child. For example, U.S. Pat. No. 5,812,056 by Wilson Law discloses a child location and monitoring device that includes a child unit and a guardian unit. When the child leaves a predetermined area the child unit alerts the guardian unit to inform the guardian as to the location of the child. U.S. Pat. No. 7,446,664 by Robert McCall White discloses a remote child locator wherein a stuffed toy carried by the child includes a receiver that tracks their location. The adult carries a transmitter, where upon activation the location of the receiver is determined by the adult with the transmitter. While the current devices do actively assist a guardian to determine the location of their child the devices may become boring or burdensome for the child to continuously carry or wear.

It would be beneficial in the art to provide a child locator that not also tracks the location of the child but also entertains the child. It would also be desirable in the art to provide a child locator that is comfortable to wear and is adjustable for use as the child grows.

### SUMMARY OF THE INVENTION

In view of the foregoing disadvantages inherent in the prior art, the general purpose of the present invention is to provide a child learning and safety device, configured to include all of the advantages of the prior art, and to overcome the drawbacks inherent therein.

Accordingly, an object of the present invention is to provide a learning and safety device for a child wherein the device both plays audio files and monitors the location of the child.

Another object of the present invention is to provide a learning and safety device where the device is comfortably worn by the child.

Another object of the present invention is to provide a learning and safety device wherein the device is activated to sound an alarm when the child comes within a predetermined distance of a location sensor.

To achieve the above objects, in an aspect of the present invention, a child learning and safety device is described comprising: a housing, where the housing contains a plurality of internal components; an attachment means attached to the housing, wherein the attachment means enables the housing to wrap around a body part of a child user; an audio device as one of the internal components, where the audio device plays audio files; a location processor as one of the internal components, where the location processor monitors a location of the child user; one or more location sensors attached to a fixture within a building, where the location sensor activates an alarm within the location processor when the location processor comes within a predetermined distance of the location sensor; and a set of speakers positioned on the housing, where the set of speakers play the audio files and where the set of speaker sound the alarm when the location processor is activated.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawing and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a child learning and safety device in accordance with an exemplary embodiment of the present invention.

### DETAILED DESCRIPTION OF THE DRAWINGS

The present invention relates to a device that attaches to a body part of a child, where the device plays audio files. Additionally, if the child leaves a predetermined area, an alarm sounds within the device to alert an adult as to the location of the child. The present invention provides a multifunctional child learning and safety device wherein the device plays music or educational audio files and monitor the location of the child simultaneously. Various audio files including lullabies, classical music, language lessons, counting games, science lessons or various files of the user's choosing may be downloaded into the device so that when played they may stimulate or sooth the child during use. Location sensors strategically placed around the user's home, dwelling or building activate a location processor within the device when the child comes within a predetermined distance of the sensors. This informs the adult when the child is in a place they should not be or when they exit a room they shouldn't have. The location processor also has the ability to determine the location of the child with a GPS unit that actively updates a website as to the real time location of the child in case the child is lost or was taken from the care of the guardian.

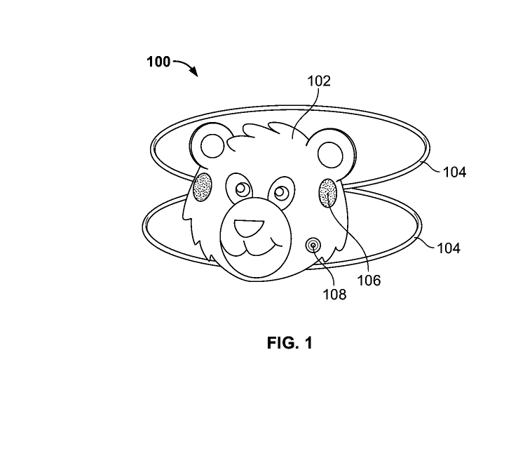

Turning now descriptively to the drawing, referring to FIG. 1, a perspective view of a child learning and safety device (100) is shown in accordance with an exemplary embodiment of the present invention. The child learning and safety device (100) includes a housing (102) to contain and protect the internal components of the device. The housing (102) may have the appearance of a plush toy for an aesthetic appeal to a child or infant. The plush toy may look like a bear (as shown), another animal, shape or similar structures commonly used as plush toys for children. Like a plush toy, the housing (102) may be padded for a soft and comfortable feel against the child user's skin, and to enable the child user to manipulate the housing (102) without injuring themselves or damaging the housing (102).

The housing (102) may include an attachment means (104) to attach the child learning and safety device (100) to a body part of the infant or child. The attachment means (104) may be a strap or sleeve to wrap around the child user's wrist, ankle or knee. The attachment means (104) may be single or a pair (as shown) to more securely attach the housing (102). The attachment means (104) may be made from elastic, rubber, nylon or another commonly used stretchable material. Likewise, the attachment means (104) may be detachable wherein the attachment means (104) includes a fastener (not shown) to secure the attachment means (104) around the child user. The fastener may be adjustable and embodied in a hook and loop fastener, buttons, clips, hooks, snaps or the like. With an adjustable fastener the attachment means (104) is able to fit the child user as they grow. As the child user grows the housing (102) may wrap around the foot like a foot covering or slipper.

Within the housing (102) are a plurality of internal components. The internal components may include an audio device, a location processor and a Global Positioning System (commonly known as a GPS) unit. The audio device enables the child learning and safety device (100) to play audio files saved on the audio device. The audio device may be heard outside the housing (102) through a set of speakers (106) positioned on the housing (102). The adult user may download music, educational lessons, voices or other audio files of their choosing to play on the child learning and safety device (100). The audio files are meant to sooth and educate the child user. To activate the audio device, the adult user may squeeze the housing (102) thereby pressing an activation switch to play the audio files. Accordingly, the user may press the activation switch a second time to stop the audio device from playing.

Next to the set of speakers (106) may be an outlet (108). The outlet (108) provides a location for the user to plug a cord or cable. The cord may be a power cord which attaches to an electrical outlet, thereby charging the internal components of the housing (102). Alternatively, the cable may connect to a USB plug. With the USB plug the user may connect the child learning and safety device (100) to a computer wherein they may download the audio files that play on the audio device.

The location processor within the housing (102) may assist the adult user to monitor the location of the child user. The location sensor coordinates with a plurality of location sensors. The location sensors may be attached to one or more fixtures within a building, whereby the plurality of location sensors create a barrier to contain the child user. For example, the adult user may fasten a location sensor to one or more doorways within their home to prevent the child user from leaving a room or to prevent them from going into a specific room. When the location processor comes within a predetermined distance of the location sensor the location processor is activated. At such time, the location processor activates an alarm that sounds through the set of speakers (106). The alarm may sound until the child user moves back within the boundary or until the adult user deactivates the alarm.

As an added safety feature, the location processor may upload the location of the child user to a website. The GPS unit coordinates with the location processor to monitor the exact location of the child user, and display the location on a map seen on the website. The website actively tracks and records the location of the child user once the location processor is activated. This may enable the adult user to locate the child user in cases of emergencies; especially if the child user is lost or stolen. With the child learning and safety device (100) the child user is educated by listening to the various audio files played through the speakers (106), and remains safe because the adult user is able to continuously monitor the location the child user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A child learning and safety device comprising:
a housing, where the housing contains a plurality of internal components;
an attachment means attached to the housing, wherein the attachment means enables the housing to wrap around a body part of a child user;
an audio device as one of the internal components within the housing, where the audio device plays audio files;
a location processor as one of the internal components within the housing, where the location processor monitors a location of the child user;
one or more location sensors attached to a fixture within a building, where the location sensors activate an alarm within the location processor when the location processor comes within a predetermined distance of the location sensor; and
a set of speakers positioned on the housing, where the set of speakers enable the audio files to be heard from within the housing and where the set of speaker sound the alarm when the location processor is activated.

2. The child learning and safety device according to claim 1, wherein the housing includes an outlet to connect the housing to a USB cable and in turn to a computer.

3. The child learning and safety device according to claim 2, wherein the outlet connects to a power cord.

4. The child learning and safety device according to claim 2, where the computer enables an adult user to download the music files onto the audio device.

5. The child learning and safety device according to claim 4, wherein the plurality of internal components includes a GPS unit which coordinates with the location processor to upload the location of the child user to a website seen on the computer when the housing is connected.

6. The child learning and safety device according to claim 1, wherein the attachment means is a strap.

7. The child learning and safety device according to claim 6, wherein the strap includes an adjustable fastener.

8. The child learning and safety device according to claim 7, wherein the adjustable fastener is one of a least hook and loop fasteners, buttons, clips, hooks, and snaps.

9. The child learning and safety device according to claim 1, wherein the housing is embodied as a plush toy.

10. The child learning and safety device according to claim 1, wherein the location sensors create a boundary to contain the child user, and when the child user exits the boundary the location processor is activated.

11. A method of use for a child learning and safety device comprising the steps of:
securing a housing of the child learning and safety device to a child user;
attaching one or more location sensors to one or more fixtures in a building;
activating an audio device within the housing to play audio files on the audio device;
activating a sensor processor within the housing when the child user comes within a predetermined distance of the location sensors; and
sounding an alarm within the sensor processor when the sensor processor is activated to alert an adult user as to a location of the child user.

12. The method of use for the child learning and safety device according to claim 11 further comprising the steps of:
creating a boundary with the location sensors to contain the child user within the boundary; and
alerting the adult user when the child user exits the boundary.

13. The method of use for the child learning and safety device according to claim 11 further comprising the step of checking a website to determine the location of the child user after the location processor uploads the location of the child user upon activation of the location processor.
